(19) United States
(12) Patent Application Publication
(10) Pub. No.: US 2019/0049607 A1
(43) Pub. Date: Feb. 14, 2019

(54) Cable For Land Based Seismic Array Systems

(71) Applicant: AFL Telecommunications LLC, Duncan, SC (US)

(72) Inventors: Joseph Cignarale, Greer, SC (US); Mike Turenne, Simpsonville, SC (US); Brett Villiger, Simpsonville, SC (US)

(21) Appl. No.: 16/158,905

(22) Filed: Oct. 12, 2018

Related U.S. Application Data
(62) Division of application No. 15/123,935, filed on Sep. 6, 2016.
(60) Provisional application No. 61/952,648, filed on Mar. 13, 2014.

(51) Int. Cl. G01V 1/20; G02B 6/44

(52) U.S. Cl. CPC G01V 1/201; G02B 6/4433; G02B 6/4495; G02B 6/4435; G02B 6/441; G02B 6/4432; G02B 6/4415

(57) ABSTRACT

A cable for land based seismic array system includes a plurality of fibers, an aramid strength member, and a thermo-plastic polyurethane (TPU) Jacket, wherein a total number of the plurality of fibers is greater than or equal to 48, a diameter of the cable is less than 10 millimeter (mm), and a weight of the cable per unit distance is less than 50 kilogram (Kg)/kilometer (Km).

### CROSS-REFERENCE TO RELATED APPLICATIONS

This application is based upon and claims the benefit of priority from U.S. Provisional Application No. 61/952,648, filed Mar. 13, 2014 in the United States Patent and Trademark Office, the disclosures of which are incorporated herein in its entirety by reference.

### BACKGROUND

### 1. Field

The invention is related to a cable for land based seismic array system, and more particularly a fiber optic cable design for land based seismic array system.

### 2. Related Art

The background information provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior an against the present disclosure.

Most seismic array systems in use today utilize copper cable that is extremely heavy, has limited capability and is typically deployed by coils manually. The only real benefit of copper is that it is very capable in the rugged terrain that these systems are deployed in and are simple to repair in the field. However, use of copper results in a much more heavy weight and more expensive manual deployment.

A fiber optic design is much more capable and lighter in weight allowing for more economical deployment as long as the cable can survive in the harsh environment. Accordingly, there is a need tor a fiber optic cable design for land based seismic array system.

Such a fiber optic cable may utilize bare fibers that are protected by aramid strength elements and a rugged Polyurethane jacket.

### SUMMARY

Exemplary implementations of the present invention address at least the above problems and/or disadvantages and other disadvantages not described above. Also, the present invention is not required to overcome the disadvantages described above, and an exemplary implementation of the present invention may not overcome any of the problems listed above.

According to an aspect of an exemplary embodiment, a cable includes a plurality of fibers, an aramid strength member, and a thermoplastic polyurethane (TPU) jacket, wherein a total number of the plurality of fibers is greater than or equal to 48, a diameter of the cable is less than 10 millimeter (mm), and a weight of the cable per unit distance is less than 50 kilogram (Kg)/kilometer (Km).

According to another exemplary embodiment, the cable further includes a ripcord, and a jacketed subunit.

According to another exemplary embodiment, the jacketed subunit is a polyvinyl chloride (PVC) jacketed subunit.

According to another exemplary embodiment, the PVC jacketed subunit bonds the plurality of fibers together.

According to another exemplary embodiment, a fiber strain value of the cable is less than 0.64% at 300 lbs. tensile load, which would meet the requirement of section 7.24 of the Insulated Cable Engineers Association (ICEA-S-104-696).

According to another exemplary embodiment, an optical loss value is less than 0.6 dB at 110 N/cm load, which would meet the requirements of section 7.25 of the Insulated Cable Engineers Association (ICEA-S-104-606).

According to another exemplary embodiment, the cable is configured for use in a land based seismic array system.

According to an aspect of an exemplary embodiment, a cable includes a plurality of fibers, a plurality of polyvinyl chloride (PVC) jacketed subunits, an aramid strength member, and a thermoplastic polyurethane (TPU) jacket, wherein the plurality of PVC jacketed subunits are used to bond together subgroups of the plurality of fibers, a total number of the plurality of fibers is greater than or equal to 48, a diameter of the cable is less than 10 millimeter (mm), and a weight of the cable per unit distance is less than 50 kilogram (Kg)/kilometer (Km).

According to another exemplary embodiment, the aramid strength member is an aramid strength yarn.

According to another exemplary embodiment, the plurality of PVC jacketed subunits are surrounded by the aramid strength yarn.

According to another exemplary embodiment, the plurality of fibers are bend intensive single mode fibers.

According to another exemplary embodiment, the plurality of jacketed subunits are polyvinyl chloride (PVC) jacketed subunits.

According to another exemplary embodiment, a fiber strain value of the cable is less than 0.64% at 300 lbs. tensile load, which would meet the requirements of section 7.24 of the Insulated Cable Engineers Association (ICEA-S-104-696).

According to another exemplary embodiment, an optical loss value is less than 0.6 dB at 110 N/cm load, which would meet the requirements of section 7.25 of the Insulated Cable Engineers Association (ICEA-S-104-696).

According to another exemplary embodiment, the cable is configured for use in a land based seismic array system.

### BRIEF DESCRIPTION OF THE DRAWING

FIG. 1 depicts a fiber optic cable for land based seismic array systems comprising an aramid strength member and a thermoplastic polyurethane (TPU) jacket, according to an exemplary embodiment.

FIG. 2 depicts a fiber optic cable for land based seismic array systems comprising an aramid strength member, a ripcord, a polyvinyl chloride (PVC) jacketed subunit and a thermoplastic polyurethane (TPU) jacket, according to an exemplary embodiment.

FIG. 3 depicts a fiber optic cable for land based seismic array systems comprising an aramid strength member, polyvinyl chloride (PVC) jacketed subunits around bend intensive fiber (BIF) single mode fiber and a thermoplastic polyurethane (TPU) jacket, according to another exemplary embodiment.

FIG. 4 is a table reciting properties of one non limiting embodiment of the jacket material, according to an exemplary embodiment.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

The terms used in the description are intended to describe embodiments only, and shall by no means be restrictive. Unless clearly used otherwise, expressions in a singular form include a meaning of a plural form. In the present description, an expression such as “comprising” or “including” is intended to designate, a characteristic, a number, a step, an operation, an element, a part or combinations thereof, and shall not be construed to preclude any presence or possibility of one or more other characteristics, numbers, steps, operations, elements, parts or combinations thereof.

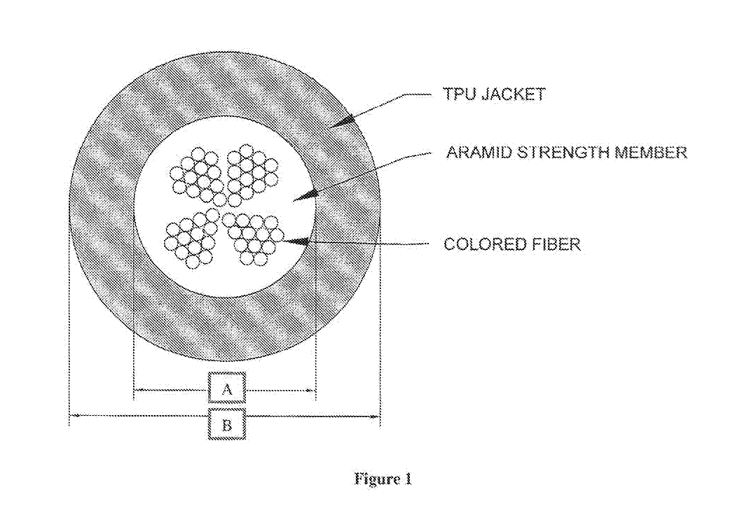

Referring to the drawings, FIG. 1 depicts a fiber optic cable for land based seismic array systems comprising an aramid strength member and a thermoplastic polyurethane (TPU) Jacket, according to an exemplary embodiment.

As shown in FIG. 1, a plurality of colored fibers are surrounded by an aramid strength member which is further surrounded by a TPU jacket.

Such a design provides several advantages over the conventionally used copper cables by providing a lighter weight design, capability of long sensing and long deployment lengths, as well as capability of deployment from a red or a truck. However, the above mentioned advantages are not limited thereto. In comparison to a standard fiber optic cable, the exemplary embodiment depicted in FIG. 1 provides a durable polyurethane jacket, a smaller lightweight design (smaller tactical style cable with a high fiber count) and aramid bonded to the jacket, thereby providing a design capable of withstanding harsh environments.

According to an exemplary embodiment of FIG. 1, the outside diameter of the aramid strength member A may be 3.4 mm and the outside diameter of the TPU jacket B may be 5.8 mm, however the measurements are not limited thereto.

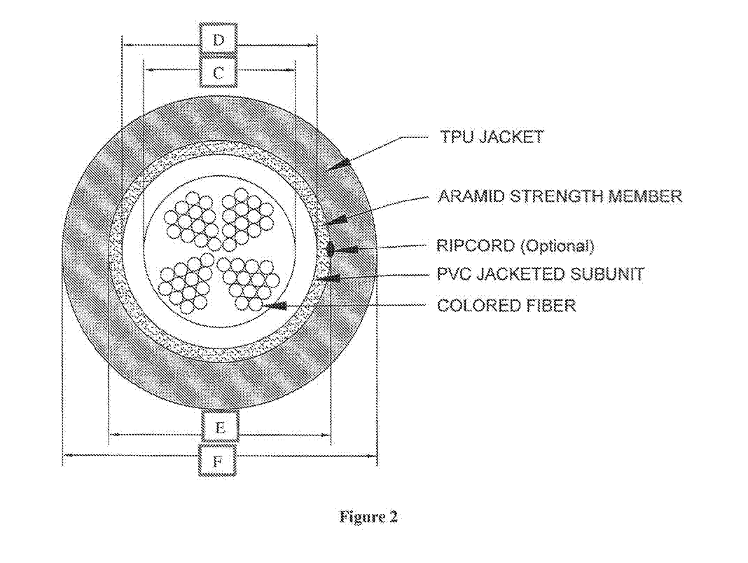

FIG. 2 depicts a fiber optic cable for land based seismic array systems comprising an aramid strength member, a ripcord, a polyvinyl chloride (PVC) jacketed subunit and a thermoplastic polyurethane (TPU) jacket, according to an exemplary embodiment.

As depicted in FIG. 2, the plurality of colored fibers are surrounded by a PVC packet subunit, which in-turn is bonded by the aramid strength member. FIG. 2 further depicts a ripcord which can be used to strip off the jacket. The aramid strength member is further surrounded by the TPU jacket according to the exemplary embodiment depicted in FIG. 2.

According to an exemplary embodiment of FIG. 2, the outside diameter of the plurality of fiber cables C may be 2.8 mm, the outside diameter of the PVC jacketed subunits D may be 3.6 mm, the outside diameter of the aramid strength member E may be 4.1 mm and the outside diameter of the TPU jacket F may be 5.8 mm, however the measurements are not limited thereto.

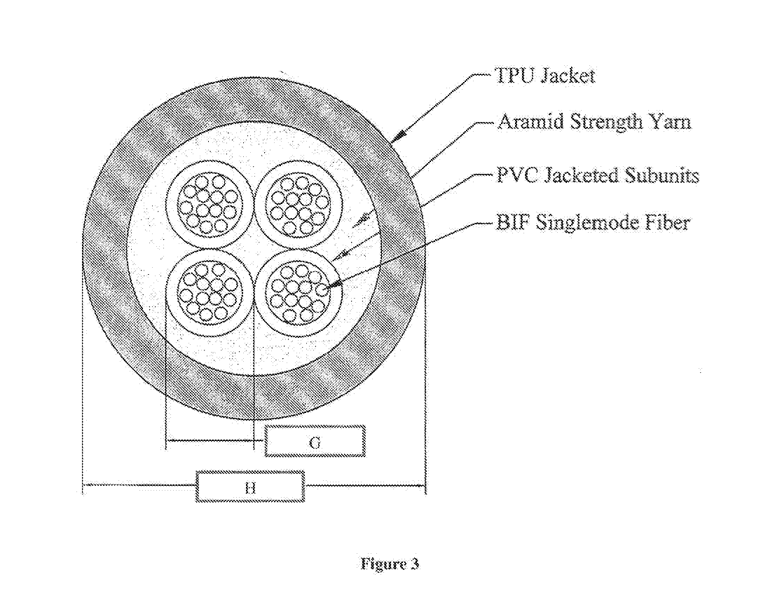

FIG. 3 depicts a fiber optic cable for land based seismic array systems comprising an aramid strength member, polyvinyl chloride (PVC) jacketed subunits around bend intensive fiber (BIF) single mode fiber and a thermoplastic polyurethane (TPU) jacket, according to another exemplary embodiment.

As shown in FIG. 3, multiple tubes of bend intensive single mode fiber may be stranded together or be deployed in parallel. Each tube may further be surrounded by PVC jacket subunits, and all the tubes may further be bonded by an aramid strength yarn. Such a design provides the ability to identify a discrete bundle to be used for transmission, which is not a possibility when all the fibers are deployed in a single bundle inside the TPU jacket.

The aramid strength yarn is further surrounded by a TPU jacket as depicted in FIG. 3.

According to an exemplary embodiment of FIG. 1, the outside diameter of the individual PVC jacketed subunits G surrounding one of the plurality of fiber bundles may be 1.8 mm and the outside diameter of the TPU jacket H may be 7 mm, however the measurements are not limited thereto.

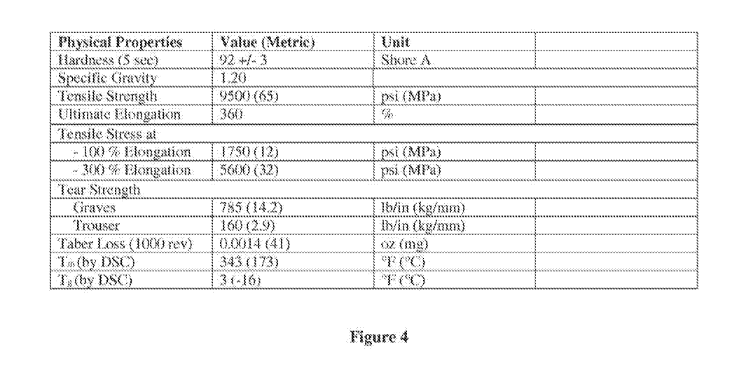

FIG. 4 is a table reciting properties of one non-limiting embodiment of the jacket material, according to an exemplary embodiment.

As shown in FIG. 4, the physical properties such as hardness, specific gravity, tensile strength, ultimate elongation, tensile stress, tear strength, taber loss, etc. has been measured for an exemplary embodiment of a jacket material for a an optical fiber cable design for land based seismic array system described above.

According to an exemplary embodiment, a hardness value of a jacket material for a an optical fiber cable design for land based seismic array system is calculated to be 92±3 shore A. The specific gravity is calculated to be 1.2. The tensile strength is calculated to be 9500 (65) psi (MPa), and the ultimate elongation is calculated to be 360%, according to an exemplary embodiment.

The tensile stress calculated at 100% elongation may be 1750 (12) psi (MPa) and at 300% elongation may be 5600 (32) psi (MPa), according to an exemplary embodiment.

The calculated tear strength at the graves may be 785 (14.2) lb./in (kg/mm) and at the trouser may be 160 (2.9) lb./in (kg/mm).

The Taber Loss (1000 rev), according to an exemplary embodiment may be 0.0014 (41) oz. (mg), the temperature (Tm) (by DSC) may be calculated to be 343 (173)° F. (° C.) and the temperature (Tg) (by DSC) may be calculated to be 3 (−16)° F. (° C.).

Although values of physical properties of an exemplary embodiment of a jacket material for a an optical fiber cable design for land based seismic array system are listed above, he values reflect only one exemplary embodiment, and thus, are not limited thereto. Different exemplary embodiments might provide different values of the above listed physical properties and may still work as a perfect substitute to the conventional copper cables for land based seismic array system.

As can be seen, the values are similar to the conventional copper cables used thereby providing a suitable alternative with a lighter weight, capability of long sensing and long deployment lengths, as well as capability of deployment from a reel or a truck.

Furthermore, using the above described optical fiber cable for land based seismic array system, provides the ability of one cable handling a plurality of gauges, unlike the conventional copper cable.

Also, the optical fiber cables are passive, thereby eliminating the need to supply power, unlike the conventional copper cables which require 2 wires to power the gauge.

Although benefits of a fiber optic cable for land based seismic array system are listed above, the benefits are not limited thereto.

As mentioned above, the embodiments described above are merely exemplary and the general inventive concept should not be limited thereto. While this specification contains many features, the features should not be construed as limitations on the scope of the disclosure or the appended claims. Certain features described in the context of separate embodiments can also be implemented in combination. Conversely, various features described in the context of a single embodiment can also be implemented in multiple embodiments separately or in any suitable sub-combination. In addition, while one use of the cable is in land based seismic array systems, the invention is not limited to use in land based seismic array systems.

1. A cable comprising:
a fiber bundle comprising a plurality of fibers;
an aramid strength member; and
a thermoplastic polyurethane (TPU) jacket, wherein
a total number of the plurality of fibers is greater than or equal to 48,
an outside diameter of the cable is less than 10 millimeter (mm),
a weight of the cable per unit distance is less than 50 kilogram (Kg)/kilometer (Km),.
an outside diameter of the fiber bundle is greater than sixty percent of an inside diameter of the cable, the inside diameter of the cable defined by an inside diameter of the TPU jacket, and
the inside diameter of the cable is less than sixty percent of the outside diameter of the cable.

2. The cable according to claim 1 further comprising: a ripcord; and a jacketed subunit.

3. The cable according to claim 2, wherein the jacketed subunit is a polyvinyl chloride (PVC) jacketed subunit.

4. The cable according to claim 3, wherein the PVC jacketed subunit bonds the plurality of fibers together.

5. The cable according to claim 1, wherein a fiber strain value of the cable is less than 0.64% at 300 lbs. tensile load.

6. The cable according to claim 1, wherein the cable is configured for use in a land based seismic array system.

7. The cable according to claim 1, wherein an optical loss value is less than 0.6 dB at 110 N/cm load.

8. A cable comprising:
a fiber bundle comprising a plurality of fibers;
a jacketed subunit surrounding the fiber bundle;
an aramid strength member surrounding the jacketed subunit, an outside diameter of the aramid strength member defining an inside diameter of the cable; and
a thermoplastic polyurethane (TPU) jacket, wherein
the jacketed subunit bonds together the plurality of fibers,
a total number of the plurality of fibers is greater than or equal to 48,
an outside diameter of the cable is less than 10 millimeter (mm),
a weight of the cable per unit distance is less than 50 kilogram (Kg)/kilometer (Km)
an outside diameter of the fiber bundle is greater than sixty percent of the inside diameter of the cable, and
a wall thickness of the TPU jacket is greater than twenty percent of the outside diameter of the cable.

9. The cable according to claim 8, wherein the aramid strength member is an aramid strength yarn.

10. (canceled)

11. The cable according to claim 8, wherein the plurality of fibers are bend intensive single mode fibers.

12. The cable according to claim 8, wherein the jacketed subunits comprises polyvinyl chloride (PVC).

13. The cable according to claim 8, wherein a fiber strain value of the cable is less than 0.64% at 300 lbs. tensile load.

14. The cable according to claim 8, wherein an optical loss value is less than 0.6 dB at 110 N/cm load.

15. The cable according to claim 8, wherein the cable is configured for use in a land based seismic array system.
